(19) United States
(12) Patent Application Publication
(10) Pub. No.: US 2001/0004598 A1
(43) Pub. Date: Jun. 21, 2001

(54) Radio communication system, portable cellular phone set, and termination response method used therefor

(76) Inventor: Ryohei Sato, Tokyo (JP)

Correspondence Address: Whitham, Curtis & Whitham, Reston International Center, Suite 900, 11800 Sunrise Valley Dr., Reston, VA, 20191, US

(21) Appl. No.: 09/735,489

(22) Filed: Dec. 14, 2000

(30) Foreign Application Priority Data
Dec. 15, 1999 (JP) 355380/1999

(51) Int. Cl. H04Q 7/20; H04B 1/38

(52) U.S. Cl. 455/445; 455/566; 455/557

(57) ABSTRACT

A radio communication system performs communication between a portable cellular phone set on the origination side and a portable cellular phone set on the termination side through a base station apparatus. The portable cellular phone set on the termination side has the function of notifying the portable cellular phone set on the origination side of a termination rejection reason with respect to a termination request from the portable cellular phone set on the origination side in a service with which the portable cellular phone set on the termination side cannot cope. The portable cellular phone set on the origination side has the function of notifying the termination rejection reason outside.

### BACKGROUND OF THE INVENTION

1. Field of the Invention

The present invention relates to a radio communication system, a portable cellular phone set, and a termination response method used therefor and, more particularly, to a termination method for termination requests in different services.

2. Description of the Prior Art

Recently, with the widespread use of portable cellular phone sets, some portable cellular phone sets have a communication function for transmitting character information, image information, and the like to other portable cellular phone sets. The above communication function is implemented by, for example, letting a portable cellular phone set have a character information input function and an image sensing function for sensing images.

Some portable cellular phone sets allow character information input devices (including handwriting input devices) and digital cameras to be connected thereto so as to transmit character information and image information from these devices to remote portable cellular phone sets. Even portable cellular phone sets having an Internet connection function have appeared on the market.

FIG. 1 shows an example of the arrangement of a radio communication system including portable cellular phone sets like those described above. Referring to FIG. 1, portable cellular phone sets (mobile stations MS) 2 and 6 can be connected to each other by radio through a base station apparatus 3, and are respectively comprised of antennas 20 and 60, radio transmission/reception sections 21 and 61, control sections 22 and 62, and interface (I/F) sections 23 and 63.

Image display adapters or the like (ADPs) 1 and 7 are respectively connected to the portable cellular phone sets 2 and 6. In this case, the image display adapters 1 and 7 respectively have interface sections 11 and 71 and cameras & displays 12 and 72, and can display identical image information and identical character information.

When the portable cellular phone set 2 is to communicate with the portable cellular phone set 6, the portable cellular phone set 2 transmits an “image plus speech” termination request to the portable cellular phone set 6 through the base station apparatus 3. If the portable cellular phone set 6 can communicate, it returns a termination response to the base station apparatus 3.

As a consequence, the base station apparatus 3 gives the portable cellular phone sets 2 and 6 access permission. The portable cellular phone sets 2 and 6 communicate with each other (communication of “image plus speech”) through the base station apparatus 3. In this case, image information sent from the portable cellular phone set 2 to the portable cellular phone set 6 is displayed on the display section (liquid crystal display or the like) (not shown) of the camera & display 72 by the image display adapter 7 or the like in the portable cellular phone set 6.

The present applicant has already proposed a technique of appropriately responding to an incoming call to a mobile unit regardless of the connection state between the mobile unit and an image terminal in a communication system constituted by a base station, mobile units connected to the base station by radio, and terminals connected to the mobile units. This technique lets each mobile unit have a monitoring means for monitoring the connection stage between the mobile unit and a terminal and a control means for performing operation for the base station in accordance with the contents monitored by the monitoring means upon reception of an incoming call from the base station.

In the above conventional radio communication system, when the portable cellular phone set on the origination side is to originate a call upon connection of an image display adapter or the like, communication cannot be performed between the portable cellular phone set on the origination and the portable cellular phone set on the termination side unless an image display adapter or the like having the same function is also connected to the portable cellular phone set on the termination side. In this case, since the communication is abruptly disconnected at the portable cellular phone set on the origination side, the user cannot know the reason for the disconnection. The same applies to the above technique proposed by the present applicant.

### SUMMARY OF THE INVENTION

The present invention has been made to solve the above problem, and has as its object to provide a radio communication system, a portable cellular phone set, and a termination response method used therefor, which can flexibly cope with communication between a portable cellular phone set on the origination side and a portable cellular phone set on the termination side even if the portable cellular phone set to which an image display adapter or the like is connected originates a call to the portable cellular phone set to which no image display adapter or the like is connected.

According to the present invention, there is provided a radio communication system for performing communication between a portable cellular phone set on an origination side and a portable cellular phone set on a termination side through a base station apparatus, wherein the portable cellular phone set on the termination side has a function of notifying the portable cellular phone set on the origination side of a termination rejection reason with respect to a termination request from the portable cellular phone set on the origination side in a service with which the portable cellular phone set on the termination side cannot cope, and the portable cellular phone set on the origination side has a function of notifying the termination rejection reason outside.

According to the present invention, there is provided another radio communication system for performing communication between a portable cellular phone set on an origination side and a portable cellular phone set on a termination side through a base station apparatus, wherein the portable cellular phone set on the termination side has a function of storing data terminated during communication by a termination request which cannot be handled because an image display adapter for providing a service different from speech communication is not connected to at least the portable cellular phone set on the termination side.

According to the present invention, there is provided a portable cellular phone set used in a radio communication system for performing communication between an origination side and a termination side through a base station apparatus, wherein the termination side has a function of notifying the origination side of a termination rejection reason with respect to a termination request from the origination side in a service with which a self-portable cellular phone set cannot cope, and the origination side has a function of notifying the termination rejection reason outside.

According to present invention, there is provided another a portable cellular phone set used in a radio communication system for performing communication between an origination side and a termination side through a base station apparatus, wherein the termination side has a function of storing data terminated during communication by a termination request which cannot be handled because an image display adapter for providing a service different from speech communication is not connected to at least the self-portable cellular phone set.

According to the present invention, there is provided a termination response method for a portable cellular phone set used in a radio communication system for performing communication between an origination side and a termination side through a base station apparatus, wherein the termination side has the step of notifying the origination side of a termination rejection reason with respect to a termination request from the origination side in a service with which a self-portable cellular phone set cannot cope, and the origination side has the step of notifying the termination rejection reason outside.

According to the present invention, there is provided another termination response method for a portable cellular phone set used in a radio communication system for performing communication between an origination side and a termination side through a base station apparatus, wherein the termination side includes the step of storing data terminated during communication by a termination request which cannot be handled because an image display adapter for providing a service different from speech communication is not connected to at least the termination side.

A radio communication system according to the present invention includes a camera, image display section, and the like which are integrated with a portable cellular phone set or detachably mounted thereon. In this system, when a portable cellular phone set to which any image display adapter or the like which provides a service different from a speech communication service is not connected or which has no corresponding function receives an incoming call from a portable cellular phone set having a function for an image display service or the like, the caller is notified of proper information (indicating that the image display service cannot be received because no image display adapter or the like is connected) by a speech message, character message, or the like.

In the radio communication system according to the present invention, when a portable cellular phone set to which any image display adapter or the like which provides a service different from a speech communication service is not connected or which has no corresponding function receives an unacceptable incoming call from a portable cellular phone set having a function for an image display service or the like, proper information is notified to the origination side to select communication in a service that can be accepted on the termination side.

When a portable cellular phone set receives an incoming call in a service which cannot be handled unless an image display adapter or the like is connected to the phone set, proper information is notified to the portable cellular phone set on the termination side, and data is stored in the portable cellular phone set on the termination side.

With this operation, even when a portable cellular phone set to which an image display adapter or the like is connected originates a call to a portable cellular phone set to which no image display adapter or the like is connected or which has no corresponding function, proper information is notified to the origination and termination sides. That is, the termination side clearly notifies the origination side of a termination rejection reason for a termination request from the origination side, which is associated with a service with which the termination side cannot cope. Alternatively, this service is switched to a service that can be used on the termination side, thereby ensuring convenience. This makes it possible to flexibly cope with communication between the portable cellular phone set on the origination side and the portable cellular phone set on the termination side.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the arrangement of a conventional radio communication system;

FIG. 2 is a block diagram showing the arrangement of a radio communication system according to the first embodiment of the present invention;

FIGS. 3A, 3B, and 3C are views showing the formats of data exchanged between the origination side and the termination side in the first embodiment, in which FIG. 3A shows an example of the data format on the origination side, FIG. 3B shows an example of the data format on the termination side without any ADP function, and FIG. 3C shows an example of the data format on the termination side with an ADP function;

FIG. 4 is a view showing examples of the data types in FIGS. 3A and 3C;

FIG. 5 is a flow chart showing the operation of a portable cellular phone set on the origination side according to the first embodiment of the present invention;

FIG. 6 is a flow chart showing the operation of a portable cellular phone set on the termination side according to the first embodiment of the present invention;

FIGS. 7A and 7B are sequence charts showing the operation of the first embodiment of the present invention, in which FIG. 7A shows a case wherein image display adapters are connected to both the portable cellular phone set on the origination side and the portable cellular phone set on the termination side, and FIG. 7B shows a case wherein no image display adapter or the like is connected to the portable cellular phone set on the termination side;

FIG. 8 is a block diagram showing the arrangement of a radio communication system according to the second embodiment of the present invention;

FIG. 9 is a flow chart showing the operation of a portable cellular phone set on the origination side according to the second embodiment of the present invention;

FIG. 10 is a flow chart showing the operation of a portable cellular phone set on the termination side according to the second embodiment of the present invention;

FIG. 11 is a partial flow chart showing the operation in a portion A in the flow chart of FIG. 10;

FIG. 12 is a sequence chart showing the operation to be performed in the second embodiment of the present invention when no image display adapter or the like is connected to the portable cellular phone set on the termination side;

FIG. 13 is a flow chart showing the operation of a portable cellular phone set on the origination side according to the third embodiment of the present invention;

FIG. 14 is a partial flow chart showing the operation in a portion B in the flow chart of FIG. 13;

FIG. 15 is a flow chart showing the operation of a portable cellular phone set on the origination side in the fourth embodiment of the present invention;

FIG. 16 is a partial flow chart showing the operation in a portion C in the flow chart of FIG. 15;

FIG. 17 is a block diagram showing the arrangement of a radio communication system according to the fifth embodiment of the present invention;

FIG. 18 is a flow chart showing the operation of a portable cellular phone set on the origination side according to the fifth embodiment of the present invention;

FIG. 19 is a flow chart showing the operation of a portable cellular phone set on the termination side according to the fifth embodiment of the present invention;

FIG. 20 is a partial flow chart showing the operation in a portion D in the flow chart of FIG. 19; and

FIG. 21 is a sequence chart showing the operation to be performed when no image display adapter or the like is connected to the portable cellular phone set on the termination side in the fifth embodiment of the present invention.

### DETAILED DESCRIPTION OF PREFERRED EMBODIMENTS

Several preferred embodiments of the present invention will be described in detail below with reference to the accompanying drawings.

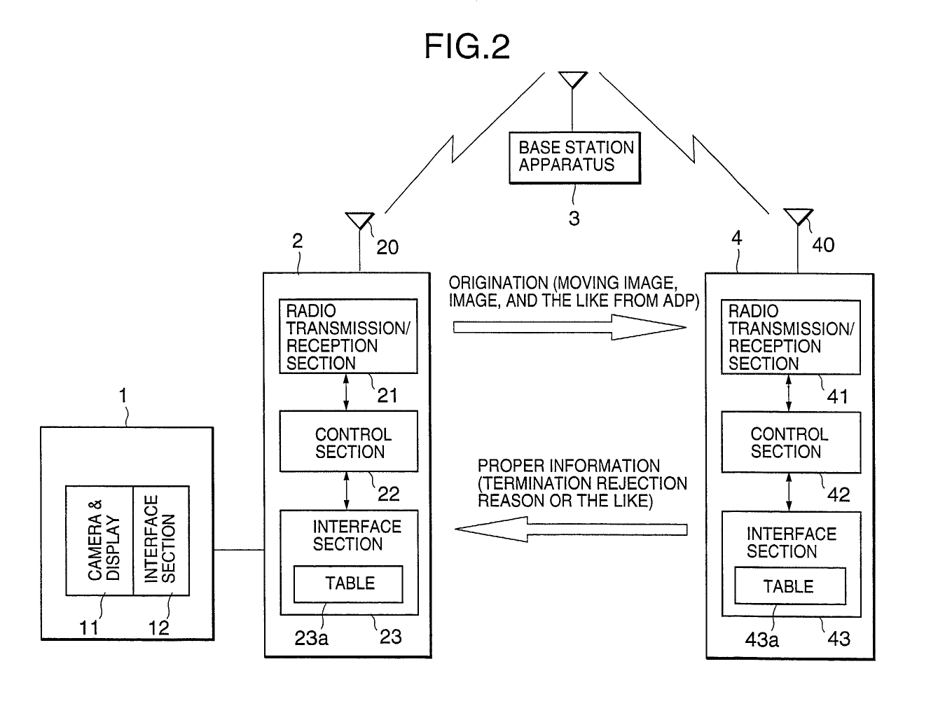

FIG. 2 is a block diagram showing the arrangement of a radio communication system according to the first embodiment of the present invention. Referring to FIG. 2, portable cellular phone sets (mobile stations MS) 2 and 4 can be connected to each other through a base station apparatus 3 and are respectively comprised of antennas 20 and 40, radio transmission/reception sections 21 and 41, control sections 22 and 42, and interface sections 23 and 43. In this case, the interface sections 23 and 43 respectively have system configuration information tables 23a and 43a.

An image display adapter (ADP) 1 or the like is connected to the portable cellular phone set 2. In this case, the image display adapter 1 or the like has an interface section 11 and camera & display 12, and allows image information, character information, and the like to be input/output.

When the portable cellular phone set 2 to which the image display adapter 1 or the like is connected is to originate a call to the portable cellular phone set 4 to which no image display adapter or the like is connected or which has no ADP function, the portable cellular phone set 4 on the termination side cannot process data.

In this case, the portable cellular phone set 4 on the termination side notifies the portable cellular phone set 2 on the origination side of proper information (e.g., a termination rejection reason indicating that no image display adapter or the like can be connected or no image data can displayed) through the base station apparatus 3.

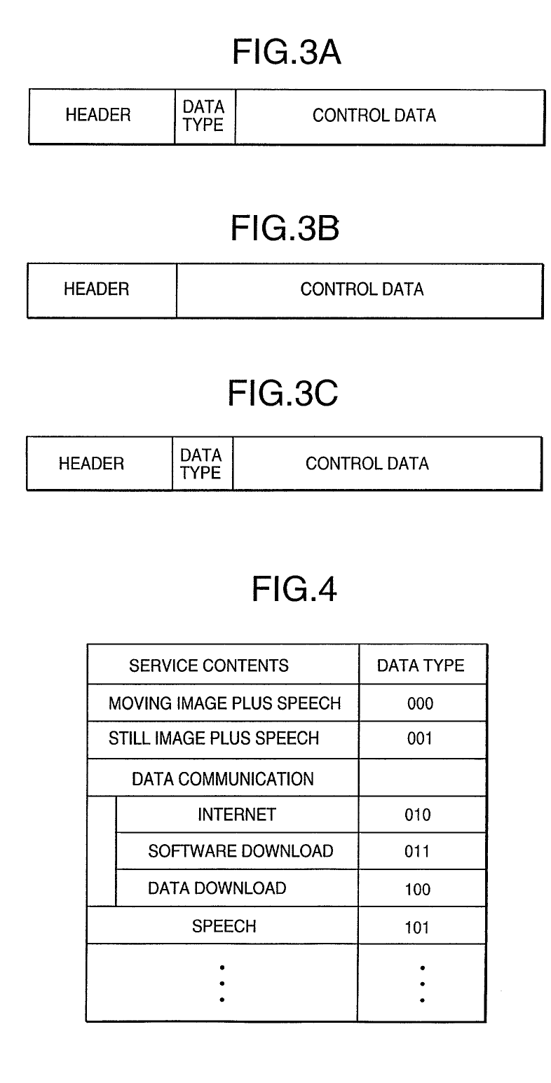

FIGS. 3A to 3C are views showing the formats of data exchanged between the origination side and the termination side in the radio communication system according to the first embodiment of the present invention. FIG. 3A shows an example of a data format on the origination side. FIG. 3B shows an example of a data format on the termination side having no ADP function. FIG. 3C shows an example of a data format on the termination side having an ADP function.

Data on the origination side is made up of a header, data type, and control data. Data on the termination side having no ADP function is made up of a header and control data. Data on the termination side having the ADP function is made up of a header, data type, and control data.

FIG. 4 is a view showing examples of the data types shown in FIGS. 3A and 3C. Referring to FIG. 4, data types are sequentially set in descending order of function, i.e., in decreasing order of data amount and data communication speed as follows: “moving image plus speech” (data type: “000”), “still image plus speech” (data type: “001”), “data communication: Internet” (data type: “010”), “data communication: software download” (data type: “011”), “data communication: data download” (data type: “100”), “speech” (data type: “101”), . . . .

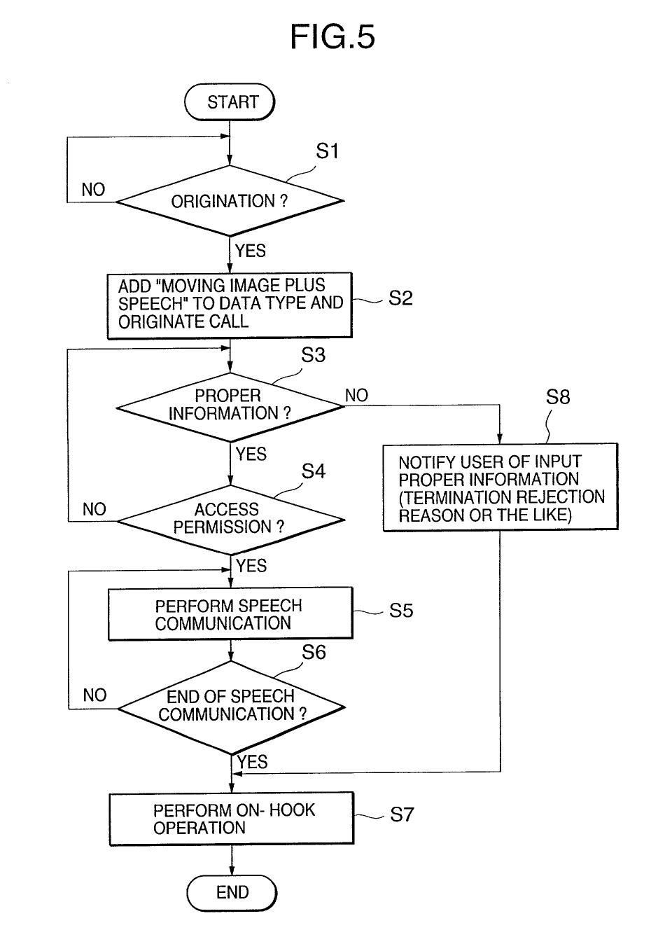

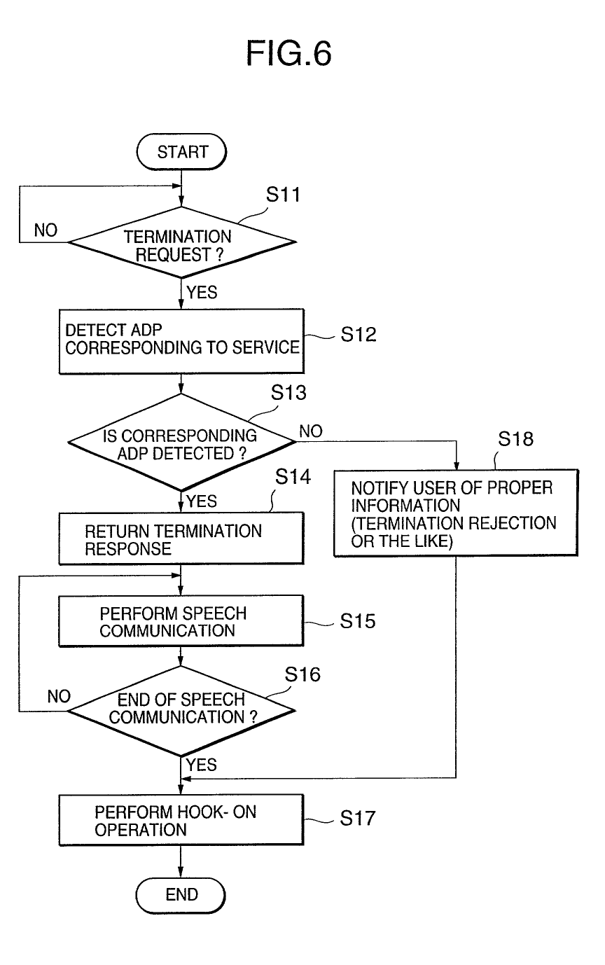

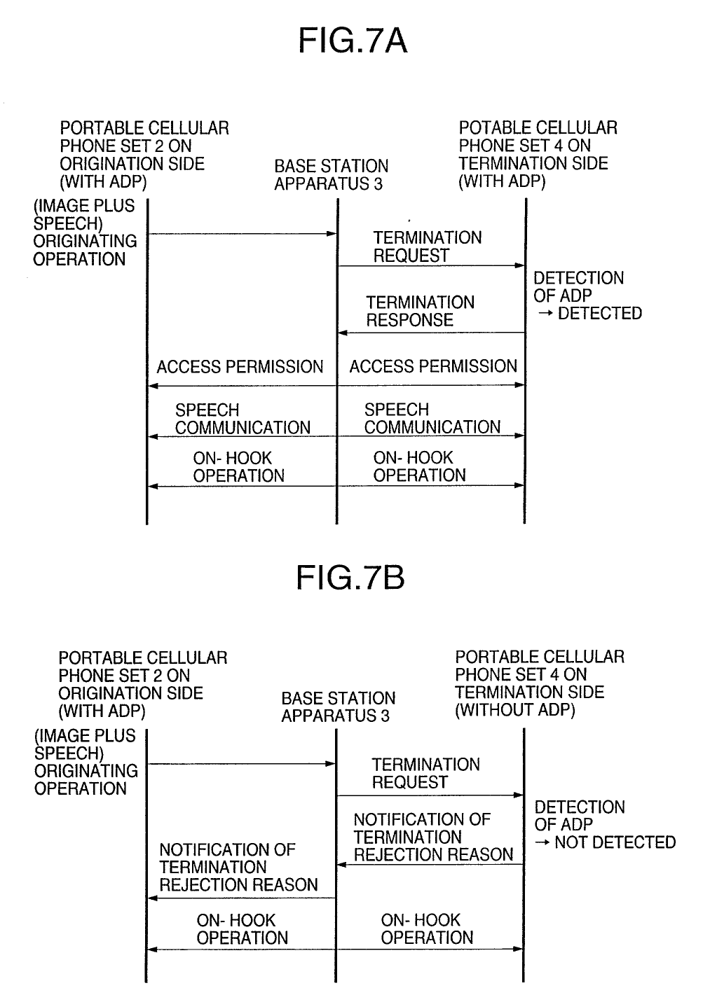

FIG. 5 is a flow chart showing the operation of the portable cellular phone set 2 on the origination side shown in FIG. 2. FIG. 6 is a flow chart showing the operation of the portable cellular phone set 4 on the termination side shown in FIG. 2. FIG. 7A is a sequence chart showing the operation of the first embodiment of the present invention in a case wherein image display adapters are connected to the portable cellular phone set 2 on the origination side and the portable cellular phone set 4 on the termination side. FIG. 7B is a sequence chart showing the operation of the first embodiment of the present invention in a case wherein no image display adapters or the like is connected to the portable cellular phone set 4 on the termination side.

The operation of the radio communication system according to the first embodiment of the present invention will be described with reference to FIGS. 2 to 7B. The operation shown in FIGS. 4 and 6 is implemented when the control sections 22 and 42 of the portable cellular phone sets 2 and 4 execute programs recorded on control memories (not shown). As the control memories, ROMs (Read-Only Memories), IC (Integrated Circuit) memories, or the like can be used.

Assume that the image display adapter 1 or the like is connected to the portable cellular phone set 2 on the origination side, and an image display adapter or the like (not shown) is also connected to the portable cellular phone set 4. The operation to be performed in this case will be described first.

When the portable cellular phone set 2 is to communicate with the portable cellular phone set 4, the control section 22 of the portable cellular phone set 2 adds an “image plus speech” code to the code type of control data sent to the base station apparatus 3, and performs originating operation for the portable cellular phone set 4 with respect to the base station apparatus 3 through the radio transmission/reception section 21 and antenna 20 (steps S1 and S2 in FIG. 5). The base station apparatus 3 transmits the termination request from the portable cellular phone set 2 to the portable cellular phone set 4.

When the radio transmission/reception section 41 receives the termination request, sent from the portable cellular phone set 2, from the base station apparatus 3 through the antenna 40 (step S11 in FIG. 6), the control section 42 of the portable cellular phone set 4 accesses the system configuration information table 43a of the interface section 43 to detect the presence/absence of a function corresponding to the service and the connection state of an image display adapter or the like (step S12 in FIG. 6).

In this case, since the image display adapter or the like is connected to the portable cellular phone set 4, the control section 42 detects the connection of the image display adapter or the like corresponding to the service through the interface section 43 (step S13 in FIG. 6). If communication can be performed, the control section 42 returns a termination response to the base station apparatus 3 (step S14 in FIG. 6).

Upon reception of the termination response from the portable cellular phone set 4, the base station apparatus 3 gives the portable cellular phone sets 2 and 4 access permission. Upon reception of the access permission from the base station apparatus 3 (step S4 in FIG. 5), the control section 22 of the portable cellular phone set 2 performs control for speech communication with the portable cellular phone set 4 through the base station apparatus 3 (step S5 in FIG. 5). Upon reception of the access permission from the base station apparatus 3, the control section 42 of the portable cellular phone set 4 performs control for speech communication with the portable cellular phone set 2 through the base station apparatus 3 (step S15 in FIG. 6).

When the speech communication with the portable cellular phone set 4 is completed (step S6 in FIG. 5), the control section 22 of the portable cellular phone set 2 performs on-hook processing for the portable cellular phone set 4 (step S7 in FIG. 5), thereby terminating the processing. Likewise, when the speech communication with the portable cellular phone set 2 is completed (step S16 in FIG. 6), the control section 42 of the portable cellular phone set 4 performs on-hook processing for the portable cellular phone set 2 (step S17 in FIG. 6), thereby terminating the processing (see FIG. 7A).

In this case, image information sent from the image display adapter 1 or the like connected to the portable cellular phone set 2 to the portable cellular phone set 4 is displayed on a display section (not shown) such as a liquid crystal display by the image display adapter or the like in the portable cellular phone set 4.

Assume that the image display adapter 1 or the like is connected to the portable cellular phone set 2 on the origination side, and no image display adapter or the like is connected to the portable cellular phone set 4 on the termination side. The operation to be performed in this case will be described next.

When the portable cellular phone set 2 is to communicate with the portable cellular phone set 4, the control section 22 of the portable cellular phone set 2 adds an “image plus speech” code to the code type of control data sent to the base station apparatus 3, and performs originating operation for the portable cellular phone set 4 with respect to the base station apparatus 3 through the radio transmission/reception section 21 and antenna 20 (steps S1 and S2 in FIG. 5). The base station apparatus 3 transmits the termination request from the portable cellular phone set 2 to the portable cellular phone set 4.

When the radio transmission/reception section 41 receives the termination request, sent from the portable cellular phone set 2, from the base station apparatus 3 through the antenna 40 (step S11 in FIG. 6), the control section 42 of the portable cellular phone set 4 accesses the system configuration information table 43a of the interface section 43 to detect the presence/absence of a function corresponding to the service and the connection state of an image display adapter or the like (step S12 in FIG. 6).

In this case, since no image display adapter or the like is connected to the portable cellular phone set 4, the control section 42 detects through the interface section 43 that no image display adapter or the like corresponding to the service is connected (step S13 in FIG. 6), and notifies the base station apparatus 3 of proper information (e.g., termination rejection reason indicating that no image display adapter or the like is connected or can be connected (step S18 in FIG. 6).

Upon reception of the proper information from the portable cellular phone set 4, the base station apparatus 3 notifies the portable cellular phone set 2 of the proper information. Upon reception of the proper information (step S3 in FIG. 5), the control section 22 of the portable cellular phone set 2 notifies the proper information indicating an inability to connect to the portable cellular phone set 4 to the user by using a speech message, a character message, or a combination thereof (step S8 in FIG. 5).

Subsequently, the base station apparatus 3 gives the portable cellular phone sets 2 and 4 an on-hook instruction, and hence the control section 22 of the portable cellular phone set 2 performs on-hook processing for the portable cellular phone set 4 (step S7 in FIG. 5), thereby terminating the processing. Likewise, the control section 42 of the portable cellular phone set 4 performs on-hook processing for the portable cellular phone set 2 (step S17 in FIG. 6), thereby terminating the processing (see FIG. 7B).

With this operation, even if the portable cellular phone set 2 to which the image display adapter 1 or the like is connected originates a call to the portable cellular phone set 4 to which no image display adapter or the like is connected or which has no corresponding function, convenience can be ensured by notifying proper information to the origination side and termination side, thereby flexibly coping with communication between the portable cellular phone set 2 on the origination side and the portable cellular phone set 4 on the termination side.

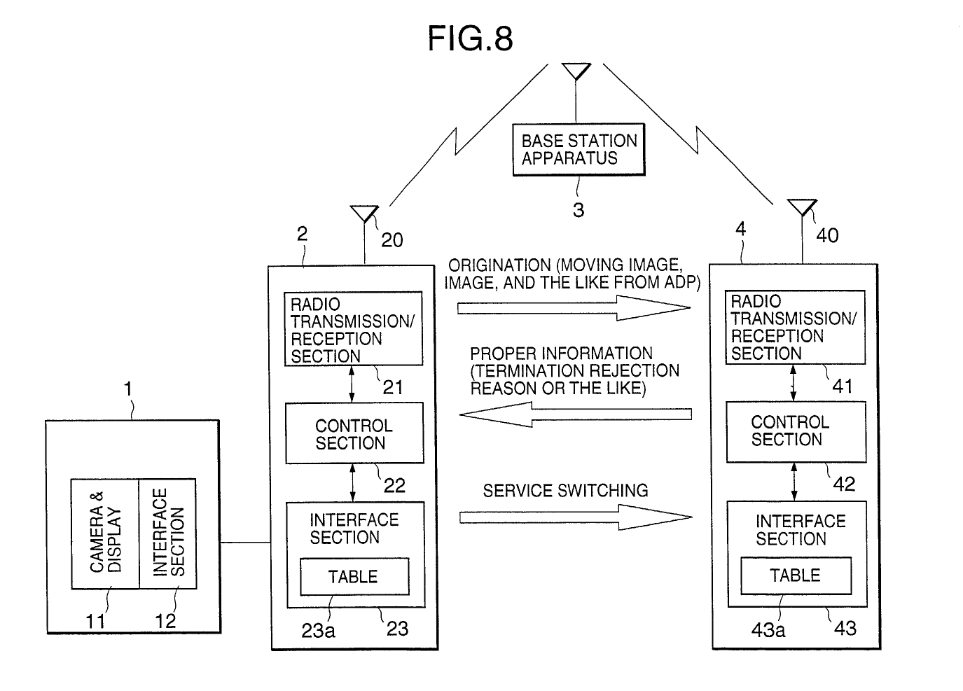

FIG. 8 is a block diagram showing the arrangement of a radio communication system according to the second embodiment of the present invention. Referring to FIG. 8, the radio communication system according to the second embodiment has the same arrangement as that of the radio communication system according to the first embodiment of the present invention except that a portable cellular phone set 2 has the function of switching to a service that can be accepted by the termination side. The same reference numerals as in the second embodiment denote the same parts in the first embodiment. In addition, the operations of the same constituent elements are the same as in the radio communication system according to the first embodiment of the present invention.

In the radio communication system according to the second embodiment of the present invention, when the portable cellular phone set 2 to which an image display adapter 1 or the like is connected originates a call to a portable cellular phone set 4 to which no image display adapter or the like is connected or which has no corresponding function, the portable cellular phone set 2 continues communication upon switching to a service that can be accepted by the portable cellular phone set 4 on the termination side on the basis of notified proper information.

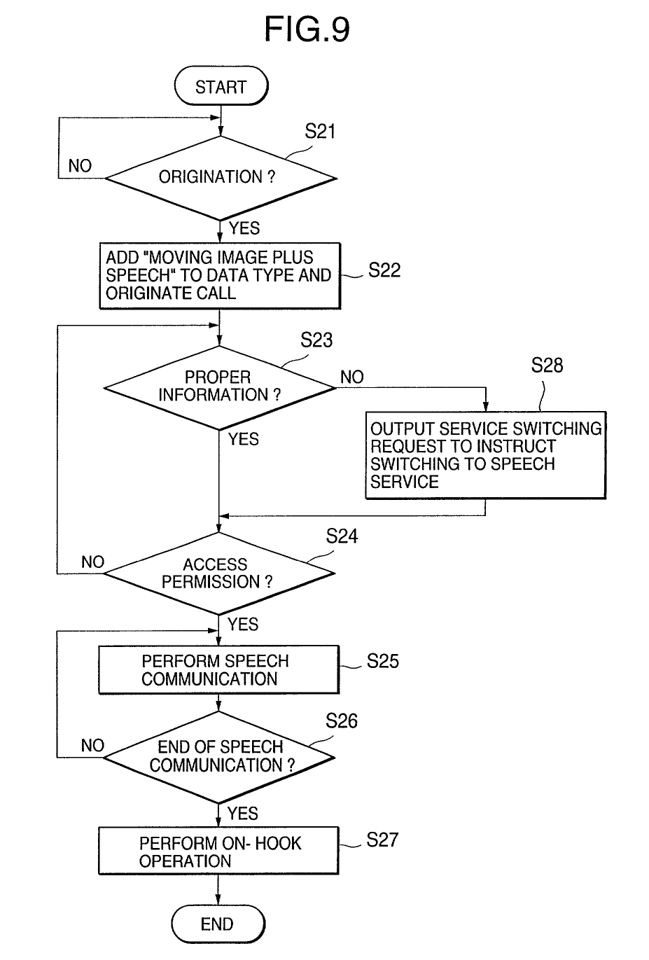

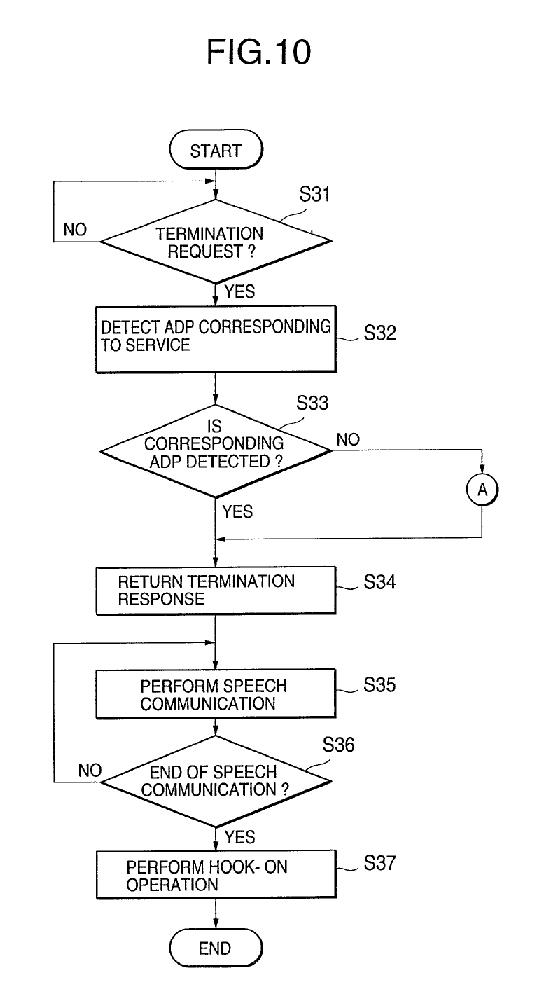

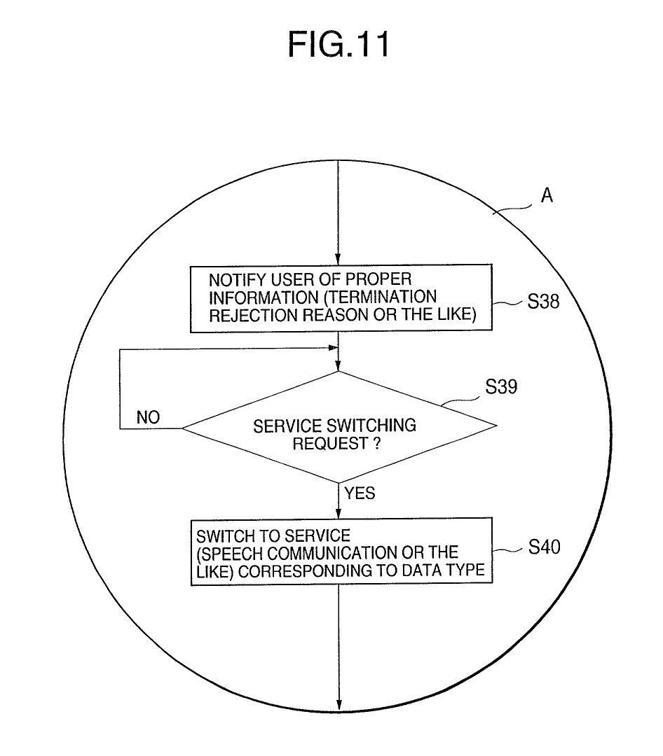

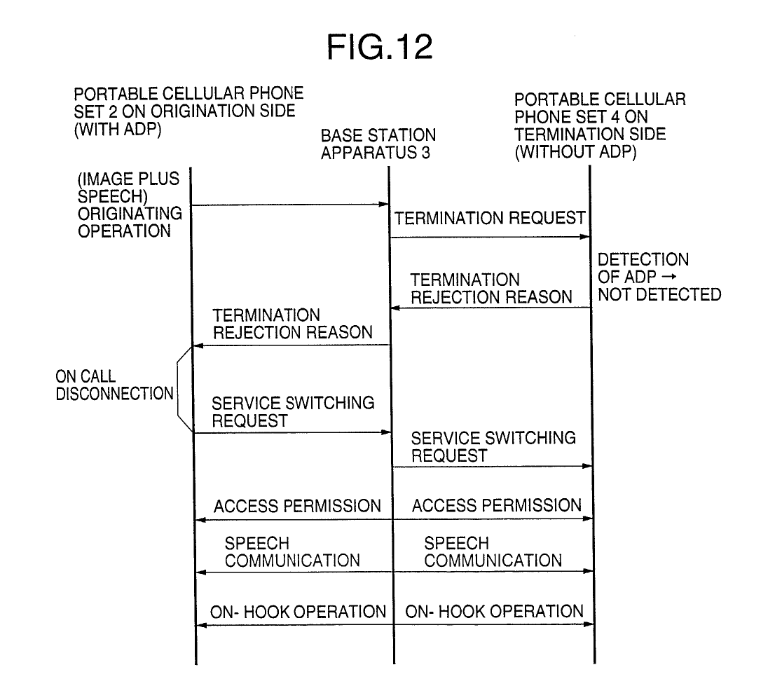

FIG. 9 is a flow chart showing the operation of the portable cellular phone set 2 on the origination side in FIG. 8. FIGS. 10 and 11 are flow charts showing the operation of the portable cellular phone set 4 on the termination side in FIG. 8. FIG. 12 is a sequence chart showing the operation to be performed when no image display adapter or the like is connected to the portable cellular phone set 4 on the termination side in the second embodiment of the present invention.

The operation of the radio communication system according to the second embodiment of the present invention will be described with reference to FIGS. 8 to 12. Note that the operation shown in FIGS. 9 to 11 is implemented when control sections 22 and 42 of the portable cellular phone sets 2 and 4 execute programs recorded on control memories (not shown). As the control memories, ROMs, IC memories, or the like can be used.

Assume that the image display adapter 1 or the like is connected to the portable cellular phone set 2 on the origination side, and an image display adapter or the like (not shown) is also connected to the portable cellular phone set 4 on the termination side. The operation to be performed in this case will be described first.

When the portable cellular phone set 2 is to communicate with the portable cellular phone set 4, the control section 22 of the portable cellular phone set 2 adds an “image plus speech” code to the code type of control data sent to a base station apparatus 3, and performs originating operation for the portable cellular phone set 4 with respect to the base station apparatus 3 through a radio transmission/reception section 21 and antenna 20 (steps S21 and S22 in FIG. 9). The base station apparatus 3 transmits the termination request from the portable cellular phone set 2 to the portable cellular phone set 4.

When a radio transmission/reception section 41 receives the termination request, sent from the portable cellular phone set 2, from the base station apparatus 3 through an antenna 40 (step S31 in FIG. 10), the control section 42 of the portable cellular phone set 4 accesses a system configuration information table 43a of an interface section 43 to detect the presence/absence of a function corresponding to the service and the connection state of an image display adapter or the like (step S32 in FIG. 10).

In this case, since the image display adapter or the like is connected to the portable cellular phone set 4, the control section 42 detects the connection of the image display adapter or the like corresponding to the service through the interface section 43 (step S33 in FIG. 10). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S24 in FIG. 9), the control section 22 of the portable cellular phone set 2 performs control for speech communication with the portable cellular phone set 4 through the base station apparatus 3 (step S25 in FIG. 9). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S26 in FIG. 9), the control section 22 of the portable cellular phone set 2 performs on-hook processing for the portable cellular phone set 4 (step S27 in FIG. 9), thereby terminating the processing. Likewise, when the speech communication with the portable cellular phone set 2 is completed (step S36 in FIG. 10), the control section 42 of the portable cellular phone set 4 performs on-hook processing for the portable cellular phone set 2 (step S37 in FIG. 10), thereby terminating the processing.

In this case, image information sent from the image display adapter 1 or the like connected to the portable cellular phone set 2 to the portable cellular phone set 4 is displayed on a display section (not shown) such as a liquid crystal display by the image display adapter or the like in the portable cellular phone set 4.

Assume that the image display adapter 1 or the like is connected to the portable cellular phone set 2 on the origination side, and no image display adapter or the like is connected to the portable cellular phone set 4 on the termination side. The operation to be performed in this case will be described next.

When the portable cellular phone set 2 is to communicate with the portable cellular phone set 4, the control section 22 of the portable cellular phone set 2 adds an “image plus speech” code to the code type of control data sent to the base station apparatus 3, and performs originating operation for the portable cellular phone set 4 with respect to the base station apparatus 3 through the radio transmission/reception section 21 and antenna 20 (steps S21 and S22 in FIG. 9). The base station apparatus 3 transmits the termination request from the portable cellular phone set 2 to the portable cellular phone set 4.

When the radio transmission/reception section 41 receives the termination request, sent from the portable cellular phone set 2, from the base station apparatus 3 through the antenna 40 (step S31 in FIG. 10), the control section 42 of the portable cellular phone set 4 accesses the system configuration information table 43a of the interface section 43 to detect the presence/absence of a function corresponding to the service and the connection state of an image display adapter or the like (step S32 in FIG. 10).

In this case, since no image display adapter or the like is connected to the portable cellular phone set 4, the control section 42 detects through the interface section 43 that no image display adapter or the like corresponding to the service is connected (step S33 in FIG. 10), and notifies the base station apparatus 3 of proper information (e.g., termination rejection reason indicating that no image display adapter or the like is connected or can be connected (step S38 in FIG. 11).

Upon reception of the proper information from the portable cellular phone set 4, the base station apparatus 3 notifies the portable cellular phone set 2 of the proper information. Upon reception of the proper information from the base station apparatus 3, the control section 22 of the portable cellular phone set 2 notifies the proper information indicating an inability to connect to the portable cellular phone set 4 to the user by using a speech message, a character message, or a combination thereof.

Upon reception of the proper information from the base station apparatus 3, in order to switch to a speech communication service, the control section 22 of the portable cellular phone set 2 generates a service switching request to instruct switching to the speech communication service by adding a “speech” code to the data type, and sends the request to the base station apparatus 3 through the radio transmission/reception section 21 and antenna 20 (step S28 in FIG. 9). In addition, the control section 22 stops sending data from the image display adapter 1 or the like. At this time, the portable cellular phone set 2 sends the service switching request without disconnecting the call. The base station apparatus 3 transmits the service switching request from the portable cellular phone set 2 to the portable cellular phone set 4.

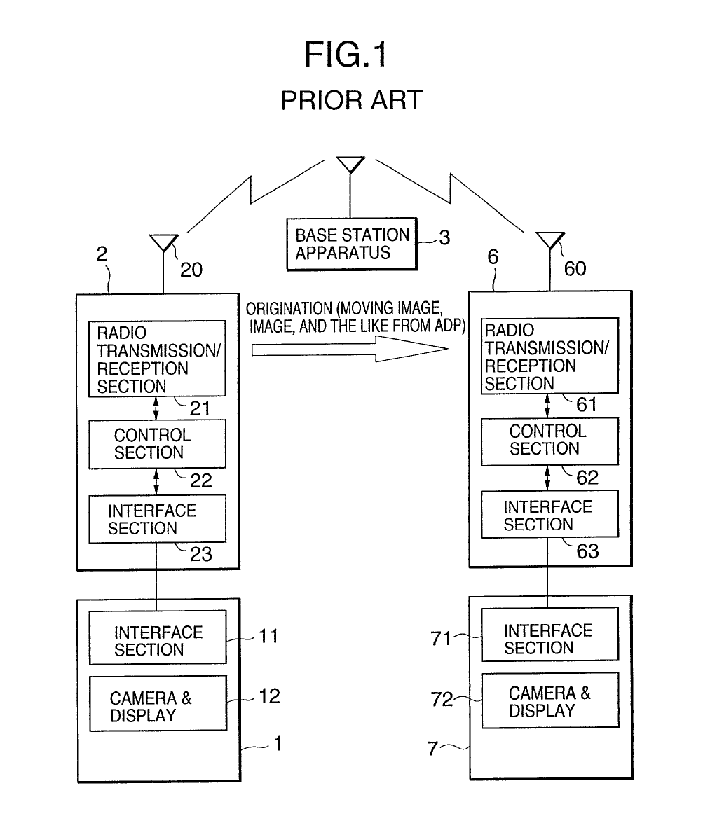

When the radio transmission/reception section 41 receives the service switching request, sent from the portable cellular phone set 2, from the base station apparatus 3 through the antenna 40 (step S39 in FIG. 1), the control section 42 of the portable cellular phone set 4 switches to the speech communication service on the basis of the data type of the service switching request (step S40 in FIG. 11). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S24 in FIG. 9), the control section 22 of the portable cellular phone set 2 performs control for speech communication with the portable cellular phone set 4 through the base station apparatus 3 (step S25 in FIG. 9). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S26 in FIG. 9), the control section 22 of the portable cellular phone set 2 performs on-hook processing for the portable cellular phone set 4 (step S27 in FIG. 9), thereby terminating the processing. Likewise, when the speech communication with the portable cellular phone set 2 is completed (step S26 in FIG. 10), the control section 42 of the portable cellular phone set 4 performs on-hook processing for the portable cellular phone set 2 (step S27 in FIG. 10), thereby terminating the processing (see FIG. 12).

With this operation, even if the portable cellular phone set 2 to which the image display adapter 1 or the like is connected originates a call to the portable cellular phone set 4 to which no image display adapter or the like is connected or which has no corresponding function, convenience can be ensured by switching to a service that can be used on the termination side, thereby flexibly coping with communication between the portable cellular phone set 2 on the origination side and the portable cellular phone set 4 on the termination side.

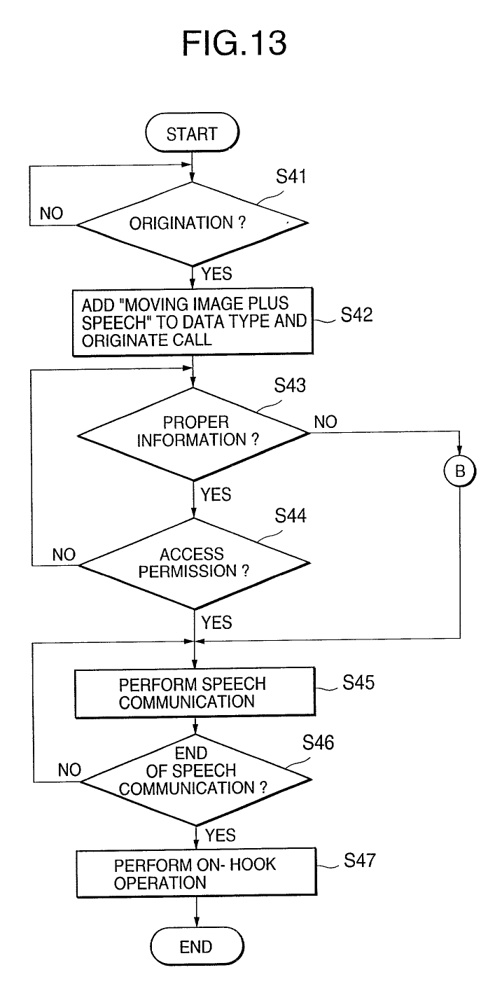

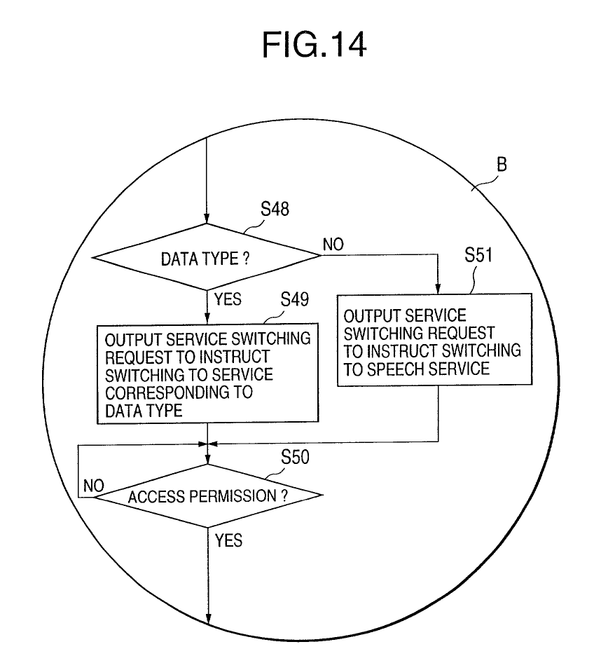

FIGS. 13 and 14 are flow charts showing the operation of a portable cellular phone set on the origination side according to the third embodiment of the present invention. The operation of the portable cellular phone set on the origination side according to the third embodiment of the present invention will be mainly described with reference to FIGS. 13 and 14. The arrangement and operation of the third embodiment of the present invention are the same as those of the second embodiment of the present invention shown in FIGS. 8 and 10 to 12 except for the operation of the portable cellular phone set on the origination side. The operation of the portable cellular phone set on the origination side according to the third embodiment of the present invention will be described with reference to FIGS. 8 and 10 to 12 as well.

The operation shown in FIGS. 13 and 14 is implemented when a control section 22 of a portable cellular phone set 2 executes programs recorded on a control memory (not shown). As the control memory, a ROM, IC memory, or the like can be used.

Assume that an image display adapter 1 or the like is connected to the portable cellular phone set 2 on the origination side, and an image display adapter or the like (not shown) is also connected to a portable cellular phone set 4. The operation to be performed in this case will be described first.

When the portable cellular phone set 2 is to communicate with the portable cellular phone set 4, the control section 22 of the portable cellular phone set 2 adds an “image plus speech” code to the code type of control data sent to a base station apparatus 3, and performs originating operation for the portable cellular phone set 4 with respect to the base station apparatus 3 through a radio transmission/reception section 21 and antenna 20 (steps S41 and S42 in FIG. 13). The base station apparatus 3 transmits the termination request from the portable cellular phone set 2 to the portable cellular phone set 4.

When a radio transmission/reception section 41 receives the termination request, sent from the portable cellular phone set 2, from the base station apparatus 3 through an antenna 40 (step S31 in FIG. 10), a control section 42 of the portable cellular phone set 4 accesses a system configuration information table 43a of an interface section 43 to detect the presence/absence of a function corresponding to the service and the connection state of an image display adapter or the like (step S32 in FIG. 10).

In this case, since the image display adapter or the like is connected to the portable cellular phone set 4, the control section 42 detects the connection of the image display adapter or the like corresponding to the service through the interface section 43 (step S33 in FIG. 10). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S44 in FIG. 13), the control section 22 of the portable cellular phone set 2 performs control for speech communication with the portable cellular phone set 4 through the base station apparatus 3 (step S45 in FIG. 13). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S46 in FIG. 13), the control section 22 of the portable cellular phone set 2 performs on-hook processing for the portable cellular phone set 4 (step S47 in FIG. 13), thereby terminating the processing. Likewise, when the speech communication with the portable cellular phone set 2 is completed (step S36 in FIG. 10), the control section 42 of the portable cellular phone set 4 performs on-hook processing for the portable cellular phone set 2 (step S37 in FIG. 10), thereby terminating the processing.

In this case, image information sent from the image display adapter 1 or the like connected to the portable cellular phone set 2 to the portable cellular phone set 4 is displayed on a display section (not shown) such as a liquid crystal display by the image display adapter or the like in the portable cellular phone set 4.

Assume that the image display adapter 1 or the like is connected to the portable cellular phone set 2 on the origination side, and no image display adapter or the like is connected to the portable cellular phone set 4 on the termination side. The operation to be performed in this case will be described next.

When the portable cellular phone set 2 is to communicate with the portable cellular phone set 4, the control section 22 of the portable cellular phone set 2 adds an “image plus speech” code to the code type of control data sent to the base station apparatus 3, and performs originating operation for the portable cellular phone set 4 with respect to the base station apparatus 3 through the radio transmission/reception section 21 and antenna 20 (steps S41 and S42 in FIG. 13). The base station apparatus 3 transmits the termination request from the portable cellular phone set 2 to the portable cellular phone set 4.

When the radio transmission/reception section 41 receives the termination request, sent from the portable cellular phone set 2, from the base station apparatus 3 through the antenna 40 (step S31 in FIG. 10), the control section 42 of the portable cellular phone set 4 accesses the system configuration information table 43a of the interface section 43 to detect the presence/absence of a function corresponding to the service and the connection state of an image display adapter or the like (step S32 in FIG. 10).

In this case, since no image display adapter or the like is connected to the portable cellular phone set 4, the control section 42 detects through the interface section 43 that no image display adapter or the like corresponding to the service is connected (step S33 in FIG. 10), and notifies the base station apparatus 3 of proper information (e.g., termination rejection reason indicating that no image display adapter or the like is connected or can be connected (step S38 in FIG. 11).

Upon reception of the proper information from the portable cellular phone set 4, the base station apparatus 3 notifies the portable cellular phone set 2 of the proper information. Upon reception of the proper information, the control section 22 of the portable cellular phone set 2 notifies the proper information indicating an inability to connect to the portable cellular phone set 4 to the user by using a speech message, a character message, or a combination thereof.

At the same time, in order to switching services, upon reception of the proper information from the base station apparatus 3, the control section 22 of the portable cellular phone set 2 checks whether a data type is added to the proper information from the base station apparatus 3 (step S48 in FIG. 14).

If a data type is added to the proper information from the base station apparatus 3, the control section 22 generates a service switching request to instruct switching to a service corresponding to the data type, and sends it to the base station apparatus 3 through the radio transmission/reception section 21 and antenna 20 (step S49 in FIG. 14), and stops sending data from the image display adapter 1 or the like. At this time, the portable cellular phone set 2 sends the service switching request without disconnecting the call. The base station apparatus 3 transmits the service switching request from the portable cellular phone set 2 to the portable cellular phone set 4.

In this case, since the portable cellular phone set 4 adds a code for specifying its highest function or a function designated by the user, as a data type, to the proper information, and transmits the resultant information to the base station apparatus 3, the portable cellular phone set 2 generates a service switching request for a service corresponding to the received information.

If no data type is added to the proper information from the base station apparatus 3, the control section 22 generates a service switching request, with a “speech” code being added thereto, to instruct switching to the speech communication service, and sends the request to the base station apparatus 3 through the radio transmission/reception section 21 and antenna 20 (step S51 in FIG. 14). The control section 22 also stops sending data from the image display adapter 1 or the like. The base station apparatus 3 transmits the service switching request from the portable cellular phone set 2 to the portable cellular phone set 4.

When the radio transmission/reception section 41 receives the service switching request, sent from the portable cellular phone set 2, from the base station apparatus 3 through the antenna 40 (step S39 in FIG. 1), the control section 42 of the portable cellular phone set 4 switches to the speech communication service on the basis of the data type of the service switching request (step S40 in FIG. 11). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S50 in FIG. 14), the control section 22 of the portable cellular phone set 2 performs control for speech communication with the portable cellular phone set 4 through the base station apparatus 3 (step S45 in FIG. 13). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S46 in FIG. 13), the control section 22 of the portable cellular phone set 2 performs on-hook processing for the portable cellular phone set 4 (step S47 in FIG. 13), thereby terminating the processing. Likewise, when the speech communication with the portable cellular phone set 2 is completed (step S26 in FIG. 10), the control section 42 of the portable cellular phone set 4 performs on-hook processing for the portable cellular phone set 2 (step S27 in FIG. 10), thereby terminating the processing (see FIG. 12).

With this operation, even if the portable cellular phone set 2 to which the image display adapter 1 or the like is connected originates a call to the portable cellular phone set 4 to which no image display adapter or the like is connected or which has no corresponding function, convenience can be ensured by switching to a service that can be used on the termination side, thereby flexibly coping with communication between the portable cellular phone set 2 on the origination side and the portable cellular phone set 4 on the termination side.

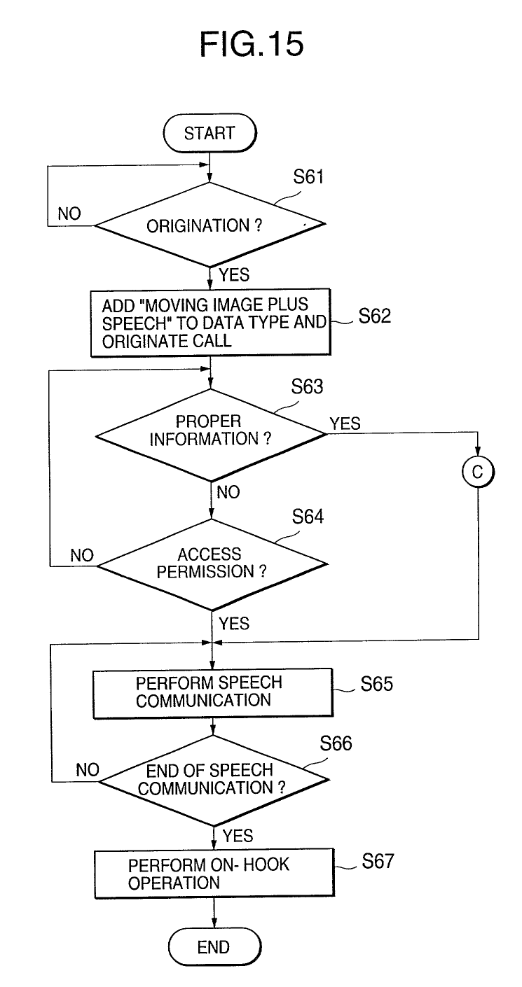

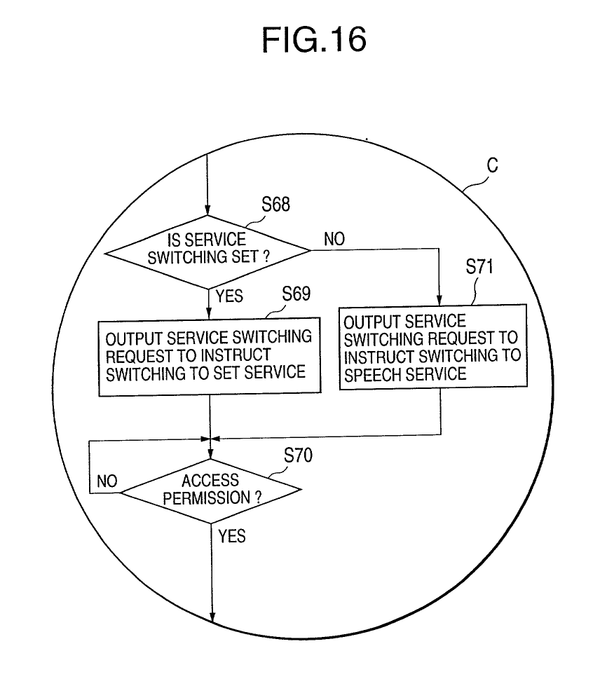

FIGS. 15 and 16 are flow charts showing the operation of a portable cellular phone set on the origination side according to the fourth embodiment of the present invention. The operation of the portable cellular phone set on the origination side according to the fourth embodiment of the present invention will be mainly described with reference to FIGS. 15 and 16. The arrangement and operation of the fourth embodiment of the present invention are the same as those of the second embodiment of the present invention shown in FIGS. 8 and 10 to 12 except for the operation of the portable cellular phone set on the origination side. The operation of the portable cellular phone set on the origination side according to the fourth embodiment of the present invention will be described with reference to FIGS. 8 and 10 to 12 as well.

The operation shown in FIGS. 15 and 16 is implemented when a control section 22 of a portable cellular phone set 2 executes programs recorded on a control memory (not shown). As the control memory, a ROM, IC memory, or the like can be used.

Assume that an image display adapter 1 or the like is connected to the portable cellular phone set 2 on the origination side, and an image display adapter or the like (not shown) is also connected to a portable cellular phone set 4. The operation to be performed in this case will be described first.

When the portable cellular phone set 2 is to communicate with the portable cellular phone set 4, the control section 22 of the portable cellular phone set 2 adds an “image plus speech” code to the code type of control data sent to a base station apparatus 3, and performs originating operation for the portable cellular phone set 4 with respect to the base station apparatus 3 through a radio transmission/reception section 21 and antenna 20 (steps S61 and S62 in FIG. 15). The base station apparatus 3 transmits the termination request from the portable cellular phone set 2 to the portable cellular phone set 4.

When a radio transmission/reception section 41 receives the termination request, sent from the portable cellular phone set 2, from the base station apparatus 3 through an antenna 40 (step S31 in FIG. 10), a control section 42 of the portable cellular phone set 4 accesses a system configuration information table 43a of an interface section 43 to detect the presence/absence of a function corresponding to the service and the connection state of an image display adapter or the like (step S32 in FIG. 10).

In this case, since the image display adapter or the like is connected to the portable cellular phone set 4, the control section 42 detects the connection of the image display adapter or the like corresponding to the service through the interface section 43 (step S33 in FIG. 10). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S64 in FIG. 15), the control section 22 of the portable cellular phone set 2 performs control for speech communication with the portable cellular phone set 4 through the base station apparatus 3 (step S65 in FIG. 15). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S66 in FIG. 15), the control section 22 of the portable cellular phone set 2 performs on-hook processing for the portable cellular phone set 4 (step S67 in FIG. 15), thereby terminating the processing. Likewise, when the speech communication with the portable cellular phone set 2 is completed (step S36 in FIG. 10), the control section 42 of the portable cellular phone set 4 performs on-hook processing for the portable cellular phone set 2 (step S37 in FIG. 10), thereby terminating the processing.

In this case, image information sent from the image display adapter 1 or the like connected to the portable cellular phone set 2 to the portable cellular phone set 4 is displayed on a display section (not shown) such as a liquid crystal display by the image display adapter or the like in the portable cellular phone set 4.

Assume that the image display adapter 1 or the like is connected to the portable cellular phone set 2 on the origination side, and no image display adapter or the like is connected to the portable cellular phone set 4 on the termination side. The operation to be performed in this case will be described next.

When the portable cellular phone set 2 is to communicate with the portable cellular phone set 4, the control section 22 of the portable cellular phone set 2 adds an “image plus speech” code to the code type of control data sent to the base station apparatus 3, and performs originating operation for the portable cellular phone set 4 with respect to the base station apparatus 3 through the radio transmission/reception section 21 and antenna 20 (steps S61 and S62 in FIG. 15). The base station apparatus 3 transmits the termination request from the portable cellular phone set 2 to the portable cellular phone set 4.

When the radio transmission/reception section 41 receives the termination request, sent from the portable cellular phone set 2, from the base station apparatus 3 through the antenna 40 (step S31 in FIG. 10), the control section 42 of the portable cellular phone set 4 accesses the system configuration information table 43a of the interface section 43 to detect the presence/absence of a function corresponding to the service and the connection state of an image display adapter or the like (step S32 in FIG. 10).

In this case, since no image display adapter or the like is connected to the portable cellular phone set 4, the control section 42 detects through the interface section 43 that no image display adapter or the like corresponding to the service is connected (step S33 in FIG. 10), and notifies the base station apparatus 3 of proper information (e.g., termination rejection reason indicating that no image display adapter or the like is connected or can be connected (step S38 in FIG. 11).

Upon reception of the proper information from the portable cellular phone set 4, the base station apparatus 3 notifies the portable cellular phone set 2 of the proper information. Upon reception of the proper information, the control section 22 of the portable cellular phone set 2 notifies the proper information indicating an inability to connect to the portable cellular phone set 4 to the user by using a speech message, a character message, or a combination thereof.

Upon reception of the proper information from the base station apparatus 3, the control section 22 of the portable cellular phone set 2 checks whether service switching is set in advance (step S68 in FIG. 16). The user can arbitrarily and manually set this service switching and a service type by using switches and the like (not shown).

If service switching is set in advance, the control section 22 generates a service switching request to instruct switching the set service, and sends the request to the base station apparatus 3 through the radio transmission/reception section 21 and antenna 20 (step S69 in FIG. 16). The control section 22 also stops sending data from the image display adapter 1 or the like. At this time, the portable cellular phone set 2 sends the service switching request without disconnecting the call. The base station apparatus 3 transmits the service switching request from the portable cellular phone set 2 to the portable cellular phone set 4.

In this case, since the portable cellular phone set 4 adds a code for specifying its highest function or a function designated by the user, as a data type, to the proper information, and transmits the resultant information to the base station apparatus 3, the portable cellular phone set 2 generates a service switching request for a service corresponding to the received information.

If no service switching set in advance, the control section 22 generates a service switching request, with a “speech” code being added thereto, to instruct switching to the speech communication service, and sends the request to the base station apparatus 3 through the radio transmission/reception section 21 and antenna 20 (step S71 in FIG. 16). The control section 22 also stops sending data from the image display adapter 1 or the like. The base station apparatus 3 transmits the service switching request from the portable cellular phone set 2 to the portable cellular phone set 4.

When the radio transmission/reception section 41 receives the service switching request, sent from the portable cellular phone set 2, from the base station apparatus 3 through the antenna 40 (step S39 in FIG. 1), the control section 42 of the portable cellular phone set 4 switches to the speech communication service on the basis of the data type of the service switching request (step S40 in FIG. 11). If communication can be performed, the control section 42 returns a termination response to the base station apparatus 3 (step S34 in FIG. 10).

Upon reception of the termination response from the portable cellular phone set 4, the base station apparatus 3 gives the portable cellular phone sets 2 and 4 access permission. Upon reception of the access permission from the base station apparatus 3 (step S70 in FIG. 16), the control section 22 of the portable cellular phone set 2 performs control for speech communication with the portable cellular phone set 4 through the base station apparatus 3 (step S65 in FIG. 15). The control section 42 of the portable cellular phone set 4 performs control for speech communication with the portable cellular phone set 2 through the base station apparatus 3 (step S35 in FIG. 10).

When the speech communication with the portable cellular phone set 4 is completed (step S66 in FIG. 15), the control section 22 of the portable cellular phone set 2 performs on-hook processing for the portable cellular phone set 4 (step S67 in FIG. 15), thereby terminating the processing. Likewise, when the speech communication with the portable cellular phone set 2 is completed (step S26 in FIG. 9), the control section 42 of the portable cellular phone set 4 performs on-hook processing for the portable cellular phone set 2 (step S27 in FIG. 9), thereby terminating the processing (see FIG. 12).

With this operation, even if the portable cellular phone set 2 to which the image display adapter 1 or the like is connected originates a call to the portable cellular phone set 4 to which no image display adapter or the like is connected or which has no corresponding function, convenience can be ensured by switching to a service that can be used on the termination side, thereby flexibly coping with communication between the portable cellular phone set 2 on the origination side and the portable cellular phone set 4 on the termination side.

In the second to fourth embodiments of the present invention, a service switching request to switch to a speech communication service is output when the condition is not satisfied. However, switching requests may be sequentially output to switch to a service ranked next to a service set when proper information is returned. The present invention is not limited to these schemes.

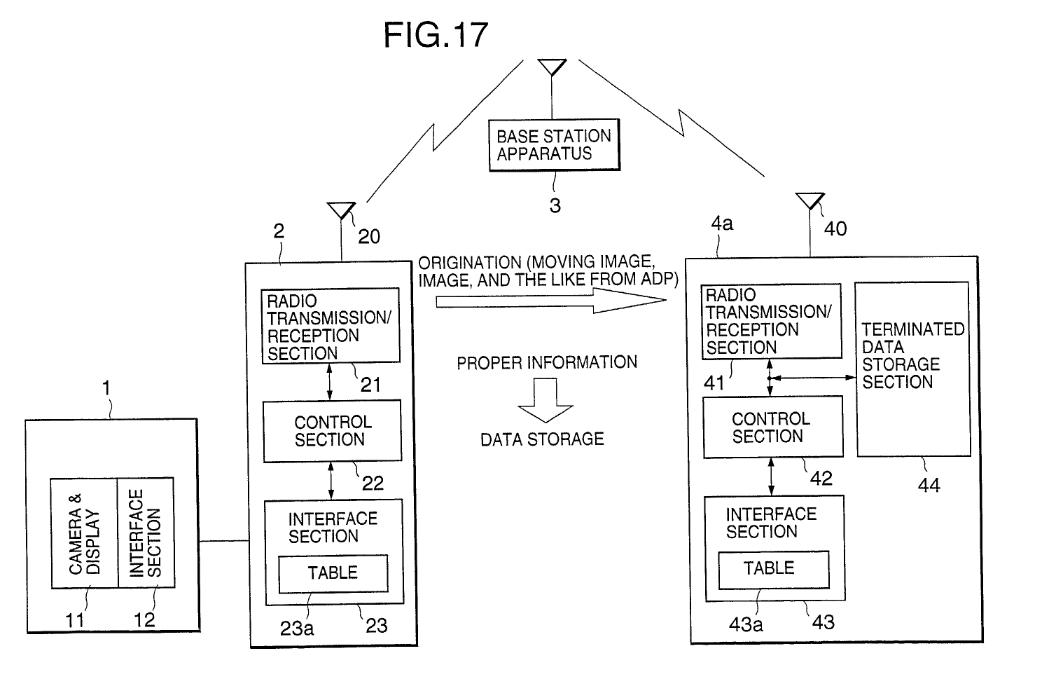

FIG. 17 is a block diagram showing the arrangement of a radio communication system according to the fifth embodiment of the present invention. Referring to FIG. 17, the radio communication system according to the fifth embodiment has the same arrangement as that of the radio communication system according to the first embodiment of the present invention except that a portable cellular phone set 4a has a terminated data storage section 44 for storing data from a portable cellular phone set 2 on the origination side. The same reference numerals as in the fifth embodiment denote the same parts in the first embodiment. In addition, the operations of the same constituent elements are the same as in the radio communication system according to the first embodiment of the present invention.

In the radio communication system according to the fifth embodiment of the present invention, when the portable cellular phone set 2 to which an image display adapter 1 or the like is connected originates a call to the portable cellular phone set 4a to which no image display adapter or the like is connected or which has no corresponding function, the portable cellular phone set 4a stores data from the portable cellular phone set 2 on the origination side in the terminated data storage section 44 to allow the data stored in the terminated data storage section 44 to be reproduced when an image display adapter or the like is connected to the portable cellular phone set 4a.

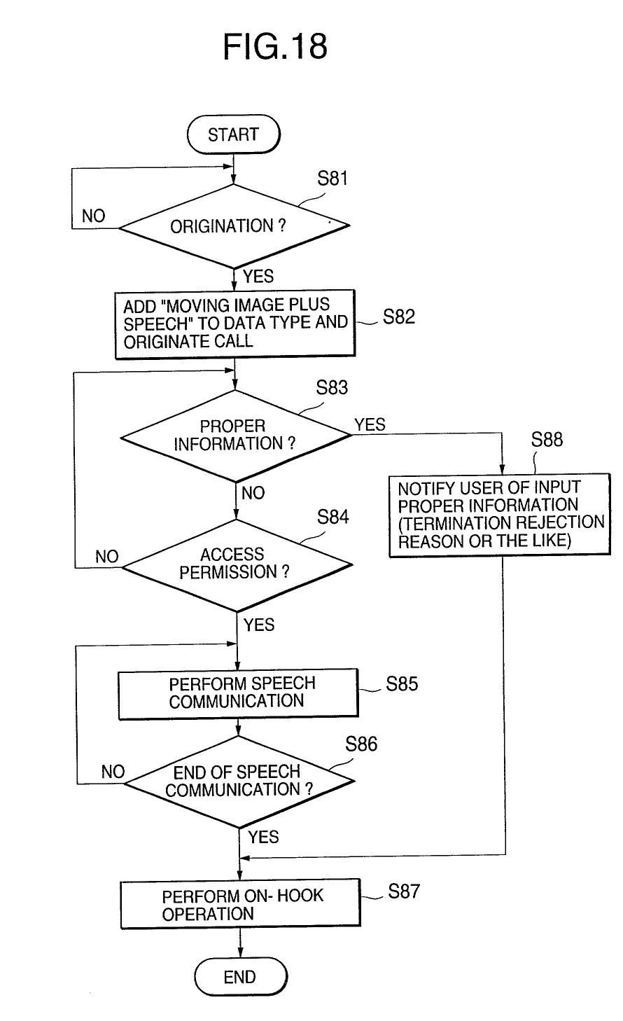

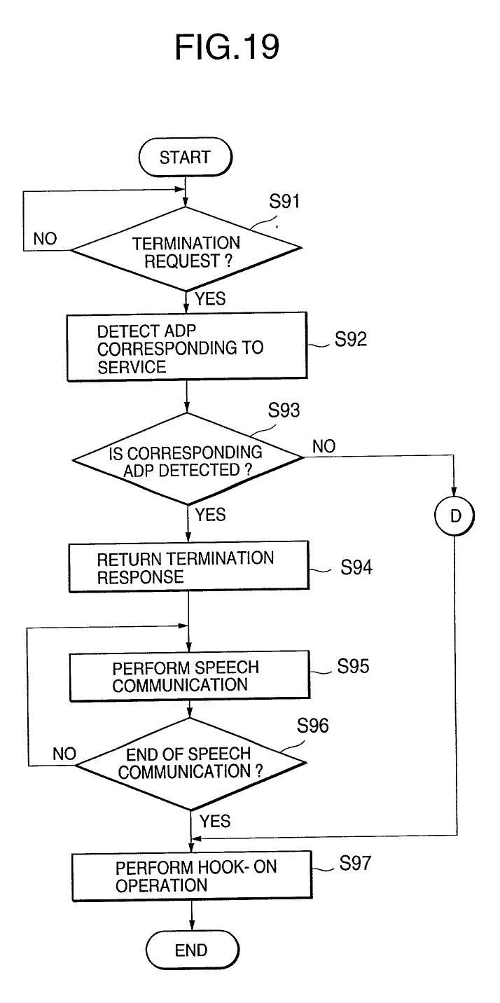

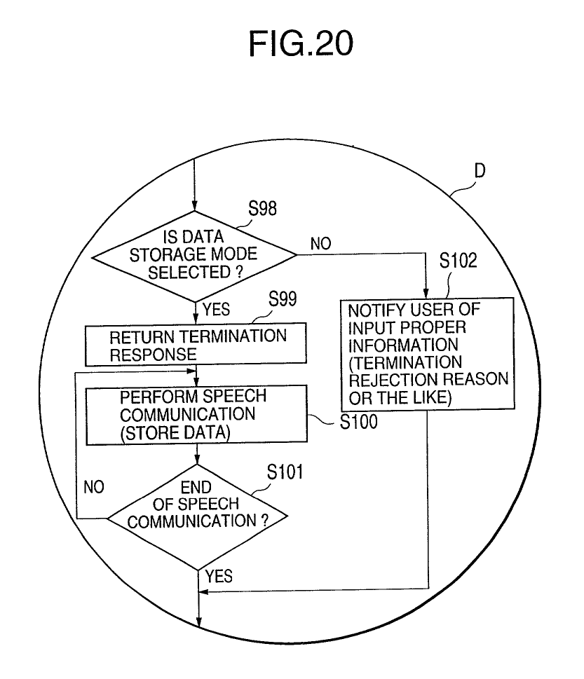

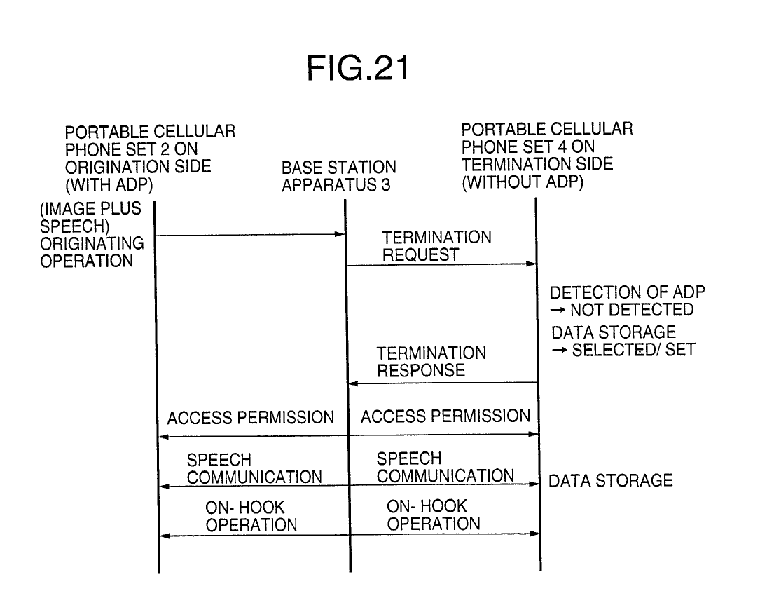

FIG. 18 is a flow chart showing the operation of the portable cellular phone set 2 on the origination side in FIG. 17. FIGS. 19 and 20 are flow charts showing the operation of the portable cellular phone set 4a on the termination side in FIG. 17. FIG. 21 is a sequence chart showing the operation to be performed when no image display adapter or the like is connected to the portable cellular phone set 4a on the termination side in the fifth embodiment of the present invention.

The operation of the radio communication system according to the fifth embodiment of the present invention will be described with reference to FIGS. 17 to 21. Note that the operation shown in FIGS. 18 to 20 is implemented when control sections 22 and 42 of the portable cellular phone sets 2 and 4 execute programs recorded on control memories (not shown). As the control memories, ROMs, IC memories, or the like can be used.

Assume that the image display adapter 1 or the like is connected to the portable cellular phone set 2 on the origination side, and an image display adapter or the like (not shown) is also connected to the portable cellular phone set 4a on the termination side. The operation to be performed in this case will be described first.

When the portable cellular phone set 2 is to communicate with the portable cellular phone set 4a, the control section 22 of the portable cellular phone set 2 adds an “image plus speech” code to the code type of control data sent to a base station apparatus 3, and performs originating operation for the portable cellular phone set 4a with respect to the base station apparatus 3 through a radio transmission/reception section 21 and antenna 20 (steps S81 and S82 in FIG. 18). The base station apparatus 3 transmits the termination request from the portable cellular phone set 2 to the portable cellular phone set 4a.

When a radio transmission/reception section 41 receives the termination request, sent from the portable cellular phone set 2, from the base station apparatus 3 through an antenna 40 (step S91 in FIG. 19), the control section 42 of the portable cellular phone set 4a accesses a system configuration information table 43a of an interface section 43 to detect the presence/absence of a function corresponding to the service and the connection state of an image display adapter or the like (step S92 in FIG. 19).

In this case, since the image display adapter or the like is connected to the portable cellular phone set 4a, the control section 42 detects the connection of the image display adapter or the like corresponding to the service through the interface section 43 (step S93 in FIG. 19). If communication can be performed, the control section 42 returns a termination response to the base station apparatus 3 (step S94 in FIG. 19).

Upon reception of the termination response from the portable cellular phone set 4a, the base station apparatus 3 gives the portable cellular phone sets 2 and 4 access permission. Upon reception of the access permission from the base station apparatus 3 (step S84 in FIG. 18), the control section 22 of the portable cellular phone set 2 performs control for speech communication with the portable cellular phone set 4a through the base station apparatus 3 (step S85 in FIG. 18). Upon reception of the access permission from the base station apparatus 3, the control section 42 of the portable cellular phone set 4a performs control for speech communication with the portable cellular phone set 2 through the base station apparatus 3 (step S95 in FIG. 19).

When the speech communication with the portable cellular phone set 4a is completed (step S86 in FIG. 18), the control section 22 of the portable cellular phone set 2 performs on-hook processing for the portable cellular phone set 4a (step S87 in FIG. 18), thereby terminating the processing. Likewise, when the speech communication with the portable cellular phone set 2 is completed (step S96 in FIG. 19), the control section 42 of the portable cellular phone set 4a performs on-hook processing for the portable cellular phone set 2 (step S97 in FIG. 19), thereby terminating the processing.

In this case, image information sent from the image display adapter 1 or the like connected to the portable cellular phone set 2 to the portable cellular phone set 4a is displayed on a display section (not shown) such as a liquid crystal display by the image display adapter or the like in the portable cellular phone set 4a.

Assume that the image display adapter 1 or the like is connected to the portable cellular phone set 2 on the origination side, and no image display adapter or the like is connected to the portable cellular phone set 4a on the termination side. The operation to be performed in this case will be described next.

When the portable cellular phone set 2 is to communicate with the portable cellular phone set 4a, the control section 22 of the portable cellular phone set 2 adds an “image plus speech” code to the code type of control data sent to the base station apparatus 3, and performs originating operation for the portable cellular phone set 4a with respect to the base station apparatus 3 through the radio transmission/reception section 21 and antenna 20 (steps S81 and S82 in FIG. 18). The base station apparatus 3 transmits the termination request from the portable cellular phone set 2 to the portable cellular phone set 4a.

When the radio transmission/reception section 41 receives the termination request, sent from the portable cellular phone set 2, from the base station apparatus 3 through the antenna 40 (step S91 in FIG. 19), the control section 42 of the portable cellular phone set 4a accesses the system configuration information table 43a of the interface section 43 to detect the presence/absence of a function corresponding to the service and the connection state of an image display adapter or the like (step S92 in FIG. 19).

In this case, since no image display adapter or the like is connected to the portable cellular phone set 4a, the control section 42 detects through the interface section 43 that no image display adapter or the like corresponding to the service is connected (step S93 in FIG. 19). If the data storage mode is not selected (step S98 in FIG. 19), the control section 42 notifies the base station apparatus 3 of proper information (e.g., termination rejection reason indicating that no image display adapter or the like is connected or can be connected (step S102 in FIG. 19).

Upon reception of the proper information from the portable cellular phone set 4a, the base station apparatus 3 notifies the portable cellular phone set 2 of the proper information. Upon reception of the proper information from the base station apparatus 3 (step S83 in FIG. 18), the control section 22 of the portable cellular phone set 2 notifies the proper information indicating an inability to connect to the portable cellular phone set 4a to the user by using a speech message, a character message, or a combination thereof (step S88 in FIG. 18).

Subsequently, the base station apparatus 3 gives the portable cellular phone sets 2 and 4a an on-hook instruction, and hence the control section 22 of the portable cellular phone set 2 performs on-hook processing for the portable cellular phone set 4a (step S87 in FIG. 18), thereby terminating the processing. Likewise, the control section 42 of the portable cellular phone set 4a performs on-hook processing for the portable cellular phone set 2 (step S97 in FIG. 19), thereby terminating the processing.

If the data storage mode is selected (step S98 in FIG. 20), and communication can be performed, the control section 42 of the portable cellular phone set 4a returns a termination response to the base station apparatus 3 (step S99 in FIG. 20).

Upon reception of the termination response from the portable cellular phone set 4a, the base station apparatus 3 gives the portable cellular phone set 2 and portable cellular phone set 4a access permission. The control section 42 of the portable cellular phone set 4a therefore performs control for speech communication with the portable cellular phone set 2 through the base station apparatus 3 (step S100 in FIG. 20). At this time, the terminated data from the portable cellular phone set 2 is stored in the terminated data storage section 44.

If the terminated data from the portable cellular phone set 2 are image and speech data from a TV telephone set, digital camera, or digital video camera, those data are stored in the terminated data storage section 44. However, only the image data can be selectively recorded. In addition, if the terminated data from the portable cellular phone set 2 are data for data communication, those data and software are stored in the terminated data storage section 44.

When the speech communication with the portable cellular phone set 4a is completed (step S86 in FIG. 18), the control section 22 of the portable cellular phone set 2 performs on-hook processing for the portable cellular phone set 4a (step S87 in FIG. 18), thereby terminating the processing. Likewise, when the speech communication with the portable cellular phone set 2 is completed (step S96 in FIG. 19), the control section 42 of the portable cellular phone set 4a performs on-hook processing for the portable cellular phone set 2 (step S97 in FIG. 19), thereby terminating the processing (see FIG. 21).

With this operation, even if the portable cellular phone set 2 to which the image display adapter 1 or the like is connected originates a call to the portable cellular phone set 4a to which no image display adapter or the like is connected or which has no corresponding function, convenience can be ensured by storing terminated data in the terminated data storage section 44 on the termination side, thereby flexibly coping with communication between the portable cellular phone set 2 on the origination side and the portable cellular phone set 4a on the termination side. The data stored in the terminated data storage section 44 can be reproduced when an image display adapter or the like is connected to the portable cellular phone set 4a.

As described above, when the portable cellular phone set 2 to which the image display adapter 1 or the like is connected originates a call to the portable cellular phone set 4 or 4a to which no image display adapter or the like is connected or which has no corresponding function, the portable cellular phone set 4 or 4a on the termination side may not communicate with the portable cellular phone set 2 because the portable cellular phone set 4 or 4a has no function of processing the sent data.

In this case, the portable cellular phone set 4 or 4a can notify the user of this situation by displaying proper information, or the current service is changed to a suitable service on the termination side. Alternatively, terminated data is stored. This makes it possible to prevent the user from being embarrassed by termination rejection. The situation described above may occur in a W-CDMA (Wideband-Code Division Multiple Access) scheme, in particular, which has recently studied and proposed as a communication scheme for portable cellular phone sets. The present invention can be applied to this W-CDMA scheme.

What is claimed is:

1. A radio communication system for performing communication between a portable cellular phone set on an origination side and a portable cellular phone set on a termination side through a base station apparatus, wherein said portable cellular phone set on the termination side has a function of notifying said portable cellular phone set on the origination side of a termination rejection reason with respect to a termination request from said portable cellular phone set on the origination side in a service with which said portable cellular phone set on the termination side cannot cope, and said portable cellular phone set on the origination side has a function of notifying the termination rejection reason outside.

2. A system according to claim 1, wherein said portable cellular phone set on the origination side includes a function of switching to a service with which said portable cellular phone set on the termination side can cope on the basis of the termination rejection reason from said portable cellular phone set on the termination side.

3. A system according to claim 2, wherein the function of switching to a service with which said portable cellular phone set on the termination side can cope is configured to switch to a speech communication service in response to the input termination rejection reason.

4. A system according to claim 2, wherein the function of switching to a service with which said portable cellular phone set on the termination side can cope is configured to switch to a service with which said portable cellular phone set on the termination side can cope in accordance with the presence/absence of information indicating a service type.

5. A system according to claim 4, wherein the function of switching to a service with which said portable cellular phone set on the termination side can cope is configured to switch to a service corresponding to the service type added to information indicating the service type in the termination rejection reason.

6. A system according to claim 4, wherein the function of switching to a service with which said portable cellular phone set on the termination side can cope is configured to switch to a speech communication service if information indicating the service type is not added to the termination rejection reason.

7. A system according to claim 5, wherein the function of switching to a service with which said portable cellular phone set on the termination side can cope is configured to switch to a speech communication service if information indicating the service type is not added to the termination rejection reason.

8. A system according to claim 2, wherein the function of switching to a service with which said portable cellular phone set on the termination side can cope is configured to switch to a service with which said portable cellular phone set on the termination side can cope in accordance with the presence/absence of setting of switching to the service.

9. A system according to claim 8, wherein the function of switching to a service with which said portable cellular phone set on the termination side can cope is configured to switch to a predetermined service when switching to the service is set in advance.

10. A system according to claim 8, wherein the function of switching to a service with which said portable cellular phone set on the termination side can cope is configured to switch to a speech communication service when switching to the service is not set in advance.

11. A system according to claim 9, wherein the function of switching to a service with which said portable cellular phone set on the termination side can cope is configured to switch to a speech communication service when switching to the service is not set in advance.

12. A system according to claim 1, wherein said portable cellular phone set on the termination side includes a function of storing data terminated during communication by a termination request which cannot be handled because an image display adapter for providing a service different from speech communication is not connected to at least said portable cellular phone set on the termination side.

13. A system according to claim 12, wherein the image display adapter is integrated with said portable cellular phone set.

14. A system according to claim 12, wherein the image display adapter is detachably connected to said portable cellular phone set.

15. A radio communication system for performing communication between a portable cellular phone set on an origination side and a portable cellular phone set on a termination side through a base station apparatus, wherein said portable cellular phone set on the termination side has a function of storing data terminated during communication by a termination request which cannot be handled because an image display adapter for providing a service different from speech communication is not connected to at least said portable cellular phone set on the termination side.

16. A system according to claim 15, wherein the image display adapter is integrated with said portable cellular phone set.

17. A system according to claim 15, wherein the image display adapter is detachably connected to said portable cellular phone set.

18. A portable cellular phone set used in a radio communication system for performing communication between an origination side and a termination side through a base station apparatus, wherein the termination side has a function of notifying the origination side of a termination rejection reason with respect to a termination request from the origination side in a service with which a self-portable cellular phone set cannot cope, and the origination side has a function of notifying the termination rejection reason outside.

19. A phone set according to claim 18, wherein the origination side includes a function of switching to a service with which the termination side can cope on the basis of the termination rejection reason from the termination side.

20. A phone set according to claim 19, wherein the function of switching to a service with which the termination side can cope is configured to switch to a speech communication service in response to the input termination rejection reason.

21. A phone set according to claim 19, wherein the function of switching to a service with which the termination side can cope is configured to switch to a service with which the termination side can cope in accordance with the presence/absence of information indicating a service type.

22. A phone set according to claim 21, wherein the function of switching to a service with which the termination side can cope is configured to switch to a service corresponding to the service type added to information indicating the service type in the termination rejection reason.

23. A phone set according to claim 21, wherein the function of switching to a service with which the termination side can cope is configured to switch to a speech communication service if information indicating the service type is not added to the termination rejection reason.

24. A phone set according to claim 22, wherein the function of switching to a service with which the termination side can cope is configured to switch to a speech communication service if information indicating the service type is not added to the termination rejection reason.

25. A phone set according to claim 20, wherein the function of switching to a service with which the termination side can cope is configured to switch to a service with which the termination side can cope in accordance with the presence/absence of setting of switching to the service.

26. A phone set according to claim 25, wherein the function of switching to a service with which the termination side can cope is configured to switch to a predetermined service when switching to the service is set in advance.

27. A phone set according to claim 25, wherein the function of switching to a service with which the termination side can cope is configured to switch to a speech communication service when switching to the service is not set in advance.

28. A phone set according to claim 26, wherein the function of switching to a service with which the termination side can cope is configured to switch to a speech communication service when switching to the service is not set in advance.

29. A phone set according to claim 18, wherein the termination side includes a function of storing data terminated during communication by a termination request which cannot be handled because an image display adapter for providing a service different from speech communication is not connected to at least the self-portable cellular phone set.

30. A phone set according to claim 29, wherein the image display adapter is integrated with the self-portable cellular phone set.

31. A phone set according to claim 29, wherein the image display adapter is detachably connected to the self-portable cellular phone set.

32. A portable cellular phone set used in a radio communication system for performing communication between an origination side and a termination side through a base station apparatus, wherein the termination side has a function of storing data terminated during communication by a termination request which cannot be handled because an image display adapter for providing a service different from speech communication is not connected to at least the self-portable cellular phone set.

33. A phone set according to claim 32, wherein the image display adapter is integrated with the self-portable cellular phone set.

34. A phone set according to claim 32, wherein the image display adapter is detachably connected to the self-portable cellular phone set.

35. A termination response method for a portable cellular phone set used in a radio communication system for performing communication between an origination side and a termination side through a base station apparatus, wherein the termination side has the step of notifying the origination side of a termination rejection reason with respect to a termination request from the origination side in a service with which a self-portable cellular phone set cannot cope, and the origination side has the step of notifying the termination rejection reason outside.

36. A method according to claim 35, wherein the origination side includes the step of switching to a service with which the termination side can cope on the basis of the termination rejection reason from the termination side.

37. A method according to claim 36, wherein the step of switching to a service with which the termination side can cope comprises switching to a speech communication service in response to the input termination rejection reason.

38. A method according to claim 36, wherein the step of switching to a service with which the termination side can cope comprises switching to a service with which the termination side can cope in accordance with the presence/absence of information indicating a service type.

39. A method according to claim 38, wherein the step of switching to a service with which the termination side can cope comprises switching to a service corresponding to the service type added to information indicating the service type in the termination rejection reason.

40. A method according to claim 38, wherein the step of switching to a service with which the termination side can cope comprises switching to a speech communication service if information indicating the service type is not added to the termination rejection reason.

41. A method according to claim 39, wherein the step of switching to a service with which the termination side can cope comprises switching to a speech communication service if information indicating the service type is not added to the termination rejection reason.

42. A method according to claim 36, wherein the step of switching to a service with which the termination side can cope comprises switching to a service with which the termination side can cope in accordance with the presence/absence of setting of switching to the service.

43. A method according to claim 42, wherein the step of switching to a service with which the termination side can cope comprises switching to a predetermined service when switching to the service is set in advance.

44. A method according to claim 42, wherein the step of switching to a service with which the termination side can cope comprises switching to a speech communication service when switching to the service is not set in advance.

45. A method according to claim 43, wherein the step of switching to a service with which the termination side can cope comprises switching to a speech communication service when switching to the service is not set in advance.

46. A method according to claim 35, wherein the termination side includes the step of storing data terminated during communication by a termination request which cannot be handled because an image display adapter for providing a service different from speech communication is not connected to at least the termination side.

47. A method according to claim 46, wherein the image display adapter is integrated with the portable cellular phone set.

48. A method according to claim 46, wherein the image display adapter is detachably connected to the portable cellular phone set.

49. A termination response method for a portable cellular phone set used in a radio communication system for performing communication between an origination side and a termination side through a base station apparatus, wherein the termination side includes the step of storing data terminated during communication by a termination request which cannot be handled because an image display adapter for providing a service different from speech communication is not connected to at least the termination side.

50. A method according to claim 49, wherein the image display adapter is integrated with the portable cellular phone set as a self-portable cellular phone set.

51. A method according to claim 49, wherein the image display adapter is detachably connected to the portable cellular phone set as a self-portable cellular phone set.
